(19) United States
(12) Patent Application Publication
(10) Pub. No.: US 2025/0206031 A1
(43) Pub. Date: Jun. 26, 2025

(54) LIQUID FEEDING APPARATUS, IMAGE FORMING APPARATUS, AND DIAGNOSIS METHOD FOR LIQUID FEEDING APPARATUS

(71) Applicant: Konica Minolta, Inc., Tokyo (JP)

(72) Inventor: Hirofumi NAKAGAWA, Osaka (JP)

(21) Appl. No.: 18/974,988

(22) Filed: Dec. 10, 2024

(30) Foreign Application Priority Data
Dec. 26, 2023 (JP) 2023-219711

(51) Int. Cl. B41J 2/175; B41J 29/00

(52) U.S. Cl. CPC B41J 2/17596; B41J 2/17563; B41J 2/17566; B41J 29/00; B41J 2002/17573

(57) ABSTRACT

A liquid feeding apparatus including: a flow path including a pump that feeds liquid from a first reservoir to a second reservoir, and a filter that collects foreign matters from the liquid fed; and a hardware processor, wherein the hardware processor acquires a numerical value related to a liquid feed amount of the liquid fed to the second reservoir by driving the pump with at least one second set value different from a first set value related to a normally used driving force, and diagnoses a deterioration level of at least one of the pump and the filter based on the numerical value.

### CROSS REFERENCE TO RELATED APPLICATIONS

The entire disclosure of Japanese Patent Application No. 2023-219711 filed on Dec. 26, 2023 is incorporated herein by reference in its entirety.

### BACKGROUND

### Technological Field

The present invention relates to a liquid feeding apparatus, an image forming apparatus, and a diagnosis method for a liquid feeding apparatus.

### Description of Related Art

In an image forming apparatus of an inkjet method, an ink is supplied to an inkjet head using a liquid feeding apparatus. When a component constituting the liquid feeding apparatus fails, the image forming apparatus stops, resulting in a significant printing downtime.

For example, in a case where a filter that is arranged in a flow path for supplying ink and collects foreign matters is clogged, a sufficient amount of ink supply cannot be obtained, an ink supply error occurs, and the image forming apparatus may stop.

Therefore, if it is possible to monitor the degree of clogging of the filter and notify the user of filter replacement recommendation information or the like before an ink supply error occurs due to clogging of the filter, it is possible to prevent the image forming apparatus from being stopped by replacing the filter before the error occurs.

In order to diagnose the degree of clogging of the filter, a method of measuring an ink supply amount from a channel having the filter is considered. However, even in a case where the pump that supplies the ink deteriorates, for example, in a case where a leak occurs in a valve of the pump due to adhesion of solid Kimono or the like, the amount of ink supply decreases, and therefore, it is difficult to diagnose only the degree of clogging of the filter by this method.

As a diagnosis method for the degree of clogging of the filter, Japanese Unexamined Patent Publication No. 2011-201234 discloses a method of measuring respective ink supply amounts in two flow paths, i.e., a flow path via the filter and a flow path not via the filter, but this method causes an increase in size and cost of the apparatus.

### SUMMARY

An object of the present invention is to provide a liquid feeding apparatus, an image forming apparatus, and a diagnosis method for a liquid feeding apparatus that are capable of accurately diagnosing the deterioration level of at least one of a filter and a pump with a simple configuration.

In order to achieve at least one of the above-described objects, a liquid feeding apparatus reflecting one aspect of the present invention includes: a flow path including a pump that feeds liquid from a first reservoir to a second reservoir, and a filter that collects foreign matters from the liquid fed; and a hardware processor. The hardware processor acquires a numerical value related to a liquid feed amount of the liquid fed to the second reservoir by driving the pump with at least one second set value different from a first set value related to a normally used driving force, and diagnoses a deterioration level of at least one of the pump and the filter based on the numerical value.

In order to achieve at least one of the above-described objects, an image forming apparatus reflecting one aspect of the present invention includes: a first reservoir and a second reservoir that store ink; the liquid feeding apparatus according to claim 1 that feeds the ink; and an image former that forms an image using the ink supplied from the second reservoir.

In order to realize at least one of the above-described objects, in a diagnosis method for a liquid feeding apparatus reflecting one aspect of the present invention, the liquid feeding apparatus includes a flow path including a pump that feeds liquid from a first reservoir to a second reservoir, and a filter that collects foreign matters from the liquid fed, the method including: acquiring a numerical value related to a liquid feed amount of the liquid fed to the second reservoir by driving the pump with at least one set value different from a set value related to a normally used driving force, and diagnosing a deterioration level of at least one of the pump and the filter based on the numerical value.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating an example of a liquid feeding apparatus and an image forming apparatus according to an embodiment of the present invention;

FIG. 2 is a block diagram illustrating a main part of a control system of the image forming apparatus illustrated in FIG. 1;

FIG. 3 is a graph illustrating a relationship between a pump duty of a liquid feed pump and a liquid feed amount of the ink;

FIG. 4A is a graph illustrating a relationship between the filter degradation level and the liquid feeding amount of the ink in a case where the pump duty of the liquid feed pump is 20%;

FIG. 4B is a graph illustrating a relationship between the filter degradation level and the liquid feeding amount of the ink in a case where the pump duty of the liquid feed pump is 40%;

FIG. 4C is a graph illustrating a relationship between the filter degradation level and the liquid feeding amount of the ink in a case where the pump duty of the liquid feed pump is 70%;

FIG. 4D is a graph illustrating a relationship between the filter degradation level and the liquid feeding amount of the ink in a case where the pump duty of the liquid feed pump is 100%;

FIG. 5A is a graph illustrating a relationship between the pump degradation level and the liquid feed amount of ink in a case where the pump duty of the liquid feed pump is 20%;

FIG. 5B is a graph illustrating a relationship between the pump degradation level and the liquid feed amount of ink in a case where the pump duty of the liquid feed pump is 40%;

FIG. 5C is a graph illustrating a relationship between the pump degradation level and the liquid feed amount of ink in a case where the pump duty of the liquid feed pump is 70%;

FIG. 5D is a graph illustrating a relationship between the pump degradation level and the liquid feed amount of ink in a case where the pump duty of the liquid feed pump is 100%;

FIG. 6 is a flowchart illustrating a diagnosis method for the filter degradation level or the liquid feed pump in the liquid feeding apparatus illustrated in FIG. 1;

FIG. 7 is a flowchart illustrating a method of more accurately diagnosing the filter degradation level and the liquid feed pump by combining the filter diagnosis and the pump diagnosis in the liquid feeding apparatus illustrated in FIG. 1;

FIG. 8A is a diagram for explaining a method of calculating the filter degradation level and the pump degradation level by combining the filter diagnosis and the pump diagnosis, and is a diagram for explaining a method of calculating the pump degradation level from the pump diagnosis value;

FIG. 8B is a diagram illustrating a method of calculating the filter degradation level and the pump degradation level by combining the filter diagnosis and the pump diagnosis, and is a diagram illustrating a method of calculating the filter degradation level from the filter diagnosis value on the basis of the pump degradation level calculated in FIG. 8A;

FIG. 8C is a diagram illustrating a method of calculating the filter degradation level and the pump degradation level by combining the filter diagnosis and the pump diagnosis, and is a diagram illustrating a method of calculating the pump degradation level from the pump diagnosis value on the basis of the filter degradation level calculated in FIG. 8B;

FIG. 9A is a diagram for explaining an example of a method of recommending replacement of the filter of the liquid feeding apparatus and is a graph illustrating transition of the filter degradation level at a time point after 200 days from the start of use, and an approximate expression for predicting a failure time;

FIG. 9B is a diagram for explaining an example of a method of recommending replacement of the filter of the liquid feeding apparatus, and is a graph illustrating transition of the filter degradation level at a time point after two days from the start of use, and an approximate expression for predicting a failure time;

FIG. 9C is a diagram for explaining an example of a method of recommending replacement of the filter of the liquid feeding apparatus, and is a graph illustrating transition of the filter degradation level at a time point after two days from the start of use, and an approximate expression for predicting a failure time;

FIG. 10A is a diagram illustrating another example of a method of recommending replacement of the filter of the liquid feeding apparatus, and is a graph illustrating transition of the filter degradation level at a time point after 200 days from the start of use and a determination value of the filter degradation level for which replacement is recommended;

FIG. 10B is a diagram illustrating another example of a method of recommending replacement of the filter of the liquid feeding apparatus, and is a graph illustrating transition of the filter degradation level at a time point after 600 days from the start of use and a determination value of the filter degradation level for which replacement is recommended; and

FIG. 10C is a diagram illustrating another example of a method of recommending replacement of the filter of the liquid feeding apparatus, and is a graph illustrating transition of the filter degradation level at a time point after 858 days from the start of use and a determination value of the filter degradation level for which replacement is recommended.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, embodiments of the present invention will be described in detail with reference to the drawings.

### Image Forming Apparatus

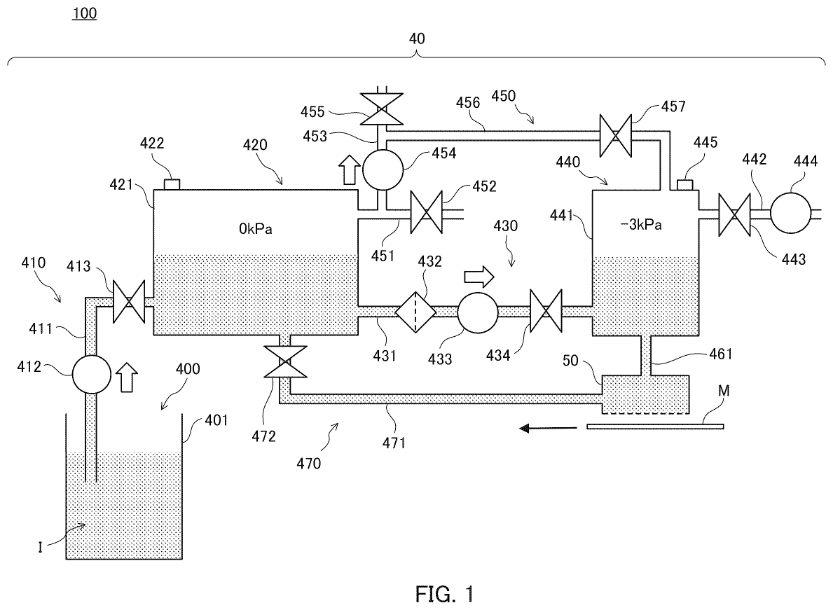

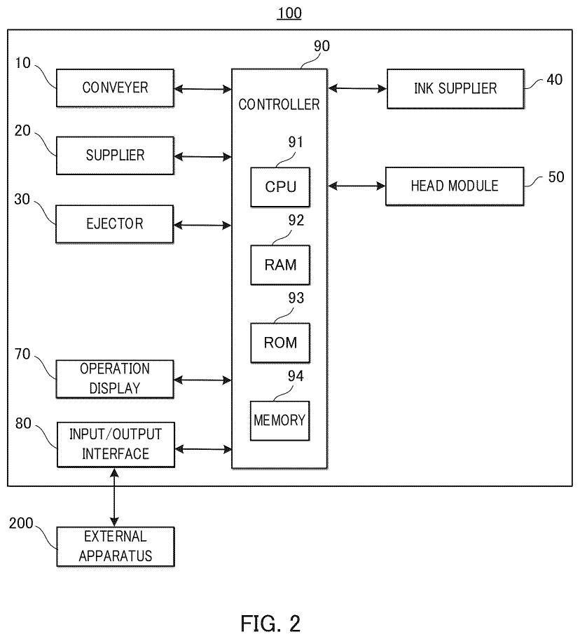

FIG. 1 is a schematic diagram illustrating an example of an ink supplier 40 and an inkjet printer 100 according to the present embodiment. FIG. 2 is a block diagram showing a main part of a control system of the inkjet printer 100 illustrated in FIG. 1.

As illustrated in FIG. 2, the ink jet printer 100 (image forming apparatus in the invention) includes a conveyer 10, a supplier 20, an ejector 30, an ink supplier 40, a head module 50, an operation display 70, an input/output interface 80, a controller 90, and the like.

The conveyer 10 conveys a recording medium M (see FIG. 1). The conveyer 10 includes, for example, a transport belt, a transport drum, or the like. The recording medium M supplied from the supplier 20 is conveyed to the head module 50 by a conveyance operation of the conveyer 10. Thereafter, the recording medium M on which the image has been formed by the head module 50 is conveyed to the ejector 30 by a conveyance operation of the conveyer 10.

As the recording medium M, various media can be used on which ink ejected from an inkjet head (not illustrated) of the head module 50 can be fixed. The recording medium M is, for example, a medium such as sheet-like paper, cloth (fabric), or resin. The recording medium M is not limited to a sheet-like medium, and may be a medium such as roll-shaped paper, cloth, or resin.

The supplier 20 stores the recording medium M and supplies the recording medium M to the conveyer 10. The supplier 20 includes, for example, a storage that accommodates the recording medium M, and includes a belt, a roller, and the like that convey the recording medium M to the conveyer 10.

The ejector 30 stores the recording medium M ejected from the conveyer 10. The ejector 30 includes, for example, a belt, a roller, or the like that conveys the recording medium M from the conveyer 10, and includes a storage that stores the recording medium M after image formation.

The ink supplier 40 (liquid feeding apparatus in the invention) is an apparatus that supplies the ink I (liquid in the invention) to the head module 50. The ink supplier 40 includes a main ink reservoir 400, a main liquid feeder 410, a first ink reservoir 420, a sub-liquid feeder 430, a second ink reservoir 440, a pressure adjuster 450, a head supply path 461, a circulator 470, and the like.

The main ink reservoir 400 stores the ink I to be fed to the first ink reservoir 420. The main ink reservoir 400 includes a main tank 401 that stores the ink I.

The main tank 401 stores the ink I, and when the stored ink I approaches empty, the ink I is replenished by a user or a service person.

The main liquid feeder 410 feeds the ink I stored in the main tank 401 to the first ink reservoir 420 (a first sub tank 421 described later). The main liquid feeder 410 includes a main supply path 411, a supply pump 412, a supply valve 413, and the like. The supply pump 412 and the supply valve 413 are arranged in this order from the upstream side to the downstream side in the liquid feeding direction.

The main supply path 411 has its end portion on the upstream side in the liquid feeding direction arranged in the main tank 401 and its end portion on the downstream side in the liquid feeding direction connected to a side surface of the first sub tank 421, and serves as a channel from the main tank 401 to the first sub tank 421.

The supply pump 412 is a pump that feeds the ink I from the main tank 401 to the first sub tank 421. The supply valve 413 opens and closes the main supply path 411.

When a liquid level sensor 422 described below detects that the liquid level of the ink I in the first sub tank 421 is at the lower limit, the controller 90 controls the supply pump 412 and the supply valve 413 to feed the ink I from the main tank 401 to the first sub tank 421.

The first ink reservoir 420 (a first reservoir in the invention) stores the ink I to be fed to the second ink reservoir 440. The first ink reservoir 420 includes the first sub tank 421 that stores the ink I, the liquid level sensor 422, and the like.

The first sub tank 421 stores the ink I, and is normally open to the atmosphere (0 kPa).

The liquid level sensor 422 measures a liquid level height of the ink I stored in the first sub tank 421. As the liquid level sensor 422, any sensor may be used as long as it can measure the liquid level height of the ink I, and for example, a magnetic sensor, an optical sensor, an electric capacitance sensor, or the like can be applied.

The sub-liquid feeder 430 (a flow path in the invention) feeds the ink I stored in the first sub tank 421 to the second ink reservoir 440 (the second sub tank 441). The sub-liquid feeder 430 includes a sub supply path 431, a filter 432, a liquid feed pump 433, and a liquid feed valve 434. The filter 432, the liquid feed pump 433, and the liquid feed valve 434 are arranged in this order from the upstream side to the downstream side in the liquid feed direction.

The sub supply path 431 connects the first sub tank 421 and the second sub tank 441 and serves as a flow path from the first sub tank 421 to the second sub tank 441. The filter 432 filters the fed ink I to collect foreign matters. A degassing module that degasses the ink I may be provided together with the filter 432.

The liquid feed pump 433 is a pump that feeds the ink I from the first sub tank 421 to the second sub tank 441. Here, as an example, the liquid feed pump 433 in which the settable minimum value of the pump duty is 20% is used, but a liquid feed pump having a different minimum value may be used as long as the liquid feed operation of the ink I can be guaranteed. The liquid feed valve 434 opens and closes the sub supply path 431. For example, when the ink I is fed from the first sub tank 421 to the second sub tank 441, the liquid feed valve 434 is opened, and when the ink I is fed from the second sub tank 441 to the head module 50, the liquid feed valve 434 is closed.

When a liquid level sensor 445 described below detects that the liquid level of the ink I in the second sub tank 441 is at the lower limit, the controller 90 controls the liquid feed pump 433 and the liquid feed valve 434 to feed the ink I from the first sub tank 421 to the second sub tank 441.

The second ink reservoir 440 (a second reservoir in the invention) stores the ink I to be fed to the head module 50. The second ink reservoir 440 includes a second sub tank 441 that stores the ink I, an air flow path 442, a back pressure valve 443, a back pressure pump 444, the liquid level sensor 445, and the like.

The second sub tank 441 is connected to the first sub tank 421 via the sub supply path 431 and is connected to the head module 50 via the head supply path 461.

The air channel 442 has one end connected to an upper portion (above an upper limit of the ink I stored inside) of the second sub tank 441 and the other end opened to the atmosphere. The backpressure valve 443 adjusts the amount of opening or closing thereof to adjust the amount of air flowing through the air channel 442. The back pressure pump 444 suctions the air in the second sub tank 441 via the air flow path 442 and the back pressure valve 443 to reduce the air pressure (back pressure) in the second sub tank 441.

The second sub tank 441 is provided with a pressure detector (not illustrated) that detects the internal air pressure. The controller 90 controls the back pressure valve 443 and the back pressure pump 444 based on the air pressure detected by the pressure detector such that the air pressure in the second sub tank 441 becomes a predetermined pressure.

At the time of printing, the controller 90 controls the air pressure in the second sub tank 441 in order to form an appropriate meniscus such that the ink I is appropriately ejected from the nozzles by the ejection operation of the inkjet heads of the head module 50. For example, as illustrated in FIG. 1, the air pressure is controlled to be −3 kPa.

The liquid level sensor 445 measures the liquid level height of the ink I stored in the second sub tank 441. As the liquid level sensor 445, any sensor may be used as long as it can measure the liquid level height of the ink I, and for example, a magnetic sensor, an optical sensor, an electric capacitance sensor, or the like can be applied.

The pressure adjuster 450 adjusts the internal air pressure of the first sub tank 421 and opens the first sub tank 421 and the second sub tank 441 to the atmosphere. The pressure adjuster 450 includes a first atmosphere opening path 451, a first atmosphere opening valve 452, a pressure adjustment path 453, a pneumatic pump 454, a pressure adjustment valve 455, a second atmosphere opening path 456, and a second atmosphere opening valve 457.

One end of the first atmosphere opening path 451 is connected to the upper portion of the first sub tank 421 (above the upper limit of the ink I stored inside), and the other end is open to the atmosphere. The first atmosphere opening valve 452 opens and closes the first atmosphere opening path 451.

The controller 90 opens the first sub tank 421 to the atmosphere or seals the first sub tank 421 by opening and closing the first atmosphere opening path 451 by controlling the first atmosphere opening valve 452.

One end of the pressure adjustment path 453 is connected to one end side of the first atmosphere opening path 451, that is, the upper portion of the first sub tank 421 (above the upper limit of the ink I stored inside), and the other end is opened to the atmosphere. The pneumatic pump 454 adjusts the air pressure (back pressure) in the first sub tank 421 and the second sub tank 441 via the pressure adjustment path 453. The pressure adjustment valve 455 adjusts the amount of the air flowing through the air flow path 442 that flows through the pressure adjustment path 453.

The controller 90 closes the first atmosphere opening valve 452 and the second atmosphere opening valve 457, and adjusts the air pressure (back pressure) in the first sub tank 421 by controlling the pneumatic pump 454 and the pressure adjustment valve 455.

One end of the second atmosphere opening path 456 is connected to the upper portion of the second sub tank 441 (above the upper limit of the ink I stored inside), and the other end is connected to the pressure adjustment path 453. The second atmosphere opening valve 457 opens and closes the second atmosphere opening path 456.

The controller 90 opens the second sub tank 441 to the atmosphere by controlling the pressure adjustment valve 455 and the second atmosphere opening valve 457 to open the pressure adjustment path 453 and the second atmosphere opening path 456. In addition, the controller 90 controls the second atmosphere opening valve 457 to close the second atmosphere opening path 456, thereby sealing the second sub tank 441.

In addition, the controller 90 closes the pressure adjustment valve 455, opens the first atmosphere opening valve 452 and the second atmosphere opening valve 457, and adjusts the air pressure (back pressure) in the second sub tank 441 by controlling the pneumatic pump 454.

The head supply path 461 is a supply path that has one end connected to a bottom part of the second sub tank 441 and the other end connected to the head module 50 and supplies the ink in the second sub tank 441 to the head module 50.

The circulator 470 circulates the ink I in the head module 50 and returns the ink I to the first sub tank 421. The circulator 470 includes a circulation path 471 and a circulation valve 472.

One end of the circulation path 471 is connected to the head module 50, and the other end thereof is connected to the first sub tank 421. The circulation valve 472 opens and closes the circulation path 471.

The controller 90 controls the circulation valve 472 to open and close the circulation path 471, thereby circulating the ink I in the head module 50 to return the ink I to the first sub tank 421 or stop the return.

For example, the circulator 470 is used for an ink circulation operation that is performed when an air bubble enters the inkjet head of the head module 50. When air bubbles enter the inkjet head, the controller 90 stops the printing operation, opens the liquid feed valve 434 and the circulation valve 472, closes the back pressure valve 443 and the second atmosphere opening path 456, and drives the liquid feed pump 433 to increase the air pressure in the second sub tank 441. The ink I containing air bubbles in the inkjet head is returned to the first sub tank 421 by the increased air pressure, and the air bubbles in the inkjet head are pushed out.

Here, as an example, the back pressure valve 443, the first atmosphere opening valve 452, and the pressure adjustment valve 455 are normally open valves that are normally open and are closed by control (supply of a predetermined drive voltage) from the controller 90. In addition, the other supply valve 413, the liquid feed valve 434, the second atmosphere opening valve 457, and the circulation valve 472 are normally closed valves that are normally closed and are opened by control (supply of a predetermined driving voltage) from the controller 90.

The head module 50 (image former in the invention) includes apparatuses and members necessary for image formation such as an ink jet head. The head module 50 ejects the ink I supplied from the ink supplier 40 (second ink reservoir 440) from the nozzles of the inkjet heads to form an image on the recording medium M.

If the nozzle of the ink jet head is clogged, the controller 90 closes the back pressure valve 443 and the pressure adjustment valve 455, opens the second atmosphere opening valve 457, and drives the pneumatic pump 454 to increase the air pressure in the second sub tank 441. The ink I in the nozzle is forcibly ejected by the increased air pressure to push out the clogging of the nozzle.

In FIG. 1, in order to simplify the drawing, the ink supplier 40 and the head module 50 for one color are illustrated, but the ink supplier 40 and the head module 50 are disposed according to the number of colors to be used. For example, when four colors of yellow (Y), magenta (M), cyan (C), and black (K) are used, the ink suppliers 40 and the head modules 50 for the four colors are arranged.

The operation display 70 is, for example, a flat panel display such as a liquid crystal display or an organic electro luminescence (EL) display with a touch panel. The operation display 70 displays an operation menu for a user, information on image data, various states of the inkjet printer 100, and the like. The operation display 70 also includes a plurality of keys and receives various input operations from the user.

The input/output interface 80 mediates transmission and reception of data between the external apparatus 200 and the controller 90. The input/output interface 80 includes, for example, various serial interfaces, various parallel interfaces, or a combination of these interfaces.

The external apparatus 200 is, for example, a personal computer or a facsimile machine and sends print jobs and image data to the controller 90 via the input/output interface 80.

The controller 90 includes a central processing unit (CPU) 91, a random access memory (RAM) 92, a read only memory (ROM) 93, and a memory 94.

The CPU 91 reads various control programs and data items stored in the ROM 93, stores the read programs and data in the RAM 92, and executes the programs to carry out various calculation processes. For example, the controller 90 generates a drive signal of an image to be formed based on image data received from the input/output interface 80, and outputs the drive signal to the head module 50.

The RAM 92 provides a working memory space for the CPU 91 and stores temporary data. Note that the RAM 92 may include a non-volatile memory.

The ROM 93 stores various control programs to be executed by the CPU 91, setting date, and the like. Note that instead of the nonvolatile memory ROM 93, a rewritable nonvolatile memory such as an electrically erasable programmable read only memory (EEPROM) or a flash memory may be used.

The memory 94 stores print jobs and image data associated with the print jobs input from an external apparatus 200 via the input/output interface 80. As the memory 94, for example, a hard disk drive (HDD) is used, and a dynamic random access memory (DRAM) or the like may be used in combination.

The conveyer 10, the supplier 20, the ejector 30, the ink supplier 40, the head module 50, the operation display 70, the input/output interface 80, and the like are each connected to the controller 90. The controller 90 integrally controls the entire operation of the inkjet printer 100. The conveyer 10, the supplier 20, the ejector 30, the ink supplier 40, the head module 50, the operation display 70, the input/output interface 80, and the like are controlled by the controller 90 to execute predetermined processing.

With the above-described configuration, the inkjet printer 100 supplies the recording medium M from the supplier 20 to the conveyer 10, forms an image on the recording medium M conveyed by the conveyer 10 with the head module 50, and conveys the recording medium M having the image to the ejector 30.

Meanwhile, in the ink jet printer 100 having the above-described configuration, in order to diagnose the degree of clogging of the filter 432, a method of measuring the supply amount of the ink I from the sub supply path 431 having the filter 432 is considered. However, even in a case where the liquid feed pump 433 that supplies the ink I is deteriorated, it is difficult to diagnose only the degree of clogging of the filter 432 by this method because the supply amount of the ink I decreases.

Therefore, in the present embodiment, the ink supplier 40 includes a diagnoser (hardware processor) described below. The diagnoser drives the liquid feed pump 433 with at least one second set value different from the first set value related to the normally used driving force, and acquires a numerical value related to the liquid feed amount fed to the second ink reservoir 440. Next, the diagnoser diagnoses the deterioration level of at least one of the liquid feed pump 433 and the filter 432 based on the acquired numerical value.

Hereinafter, the pump duty is used as the first and second set values related to the driving force for driving the liquid feed pump 433, but another set value, for example, the number of rotations may be used as long as the set value is related to the driving force. Further, hereinafter, the liquid feed amount or a liquid level rise width described later is used as a numerical value related to the liquid feed amount, but for example, a liquid feed speed or the like may be used as long as it is proportional to the liquid feed amount.

Here, the controller 90 is configured to also serve as the diagnoser in the ink supplier 40, but another controller or the like that functions as the diagnoser may be provided in the ink supplier 40 separately from the controller 90.

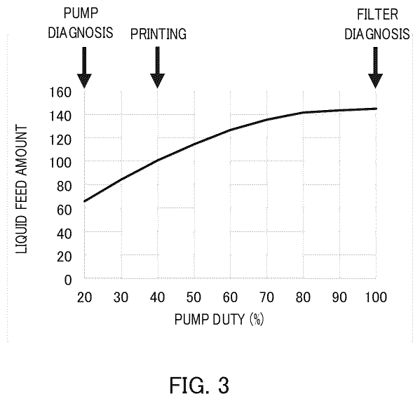

In relation to the diagnoser described above, first, the relationship between the pump duty of the liquid feed pump 433 and the liquid feed amount by which the ink I is fed will be described with reference to FIG. 3. FIG. 3 is a graph illustrating a relationship between a pump duty of the liquid feed pump 433 and a liquid feed amount by which the ink I is fed.

As illustrated in FIG. 3, the liquid feed amount of the ink I fed by the liquid feed pump 433 increases as the pump duty (%) of the liquid feed pump 433 increases. Note that in FIG. 3, the feed amount of the ink I with respect to the pump duty is graphed with the feed amount of the ink I at a pump duty of 40% used in printing as 100. In the present embodiment, the pump duty (the second set value in the present invention) at the time of pump diagnosis and the pump duty (the second set value in the present invention) at the time of filter diagnosis are set using the pump duty used at the time of printing as a reference (the first set value in the present invention).

Here, as an example, the pump duty at the time of the pump diagnosis is set to 20% and the pump duty at the time of the filter diagnosis is set to 100%, but the pump duty at the time of the pump diagnosis may be lower and the pump duty at the time of the filter diagnosis may be higher than the reference pump duty.

### Setting of Pump Duty

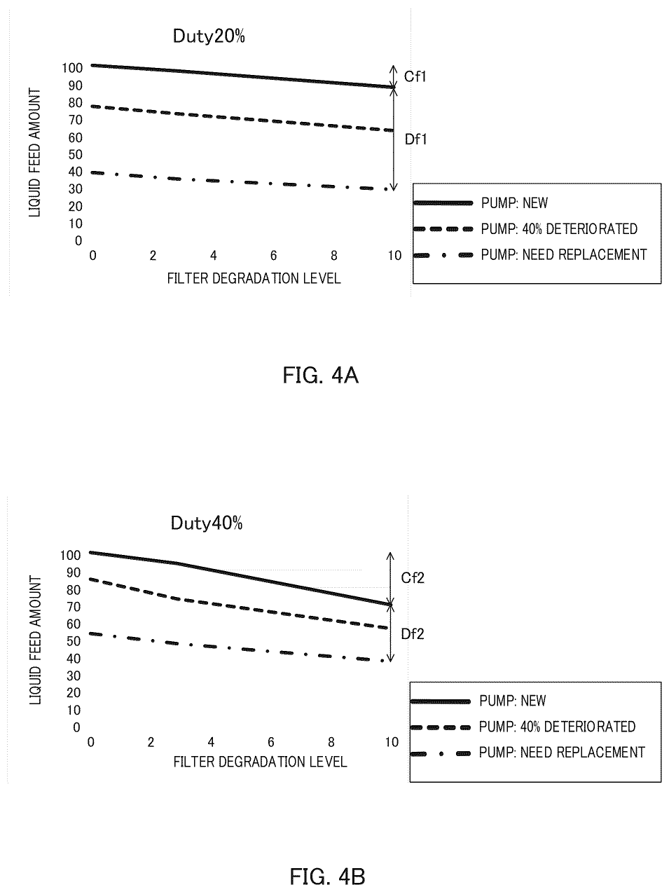

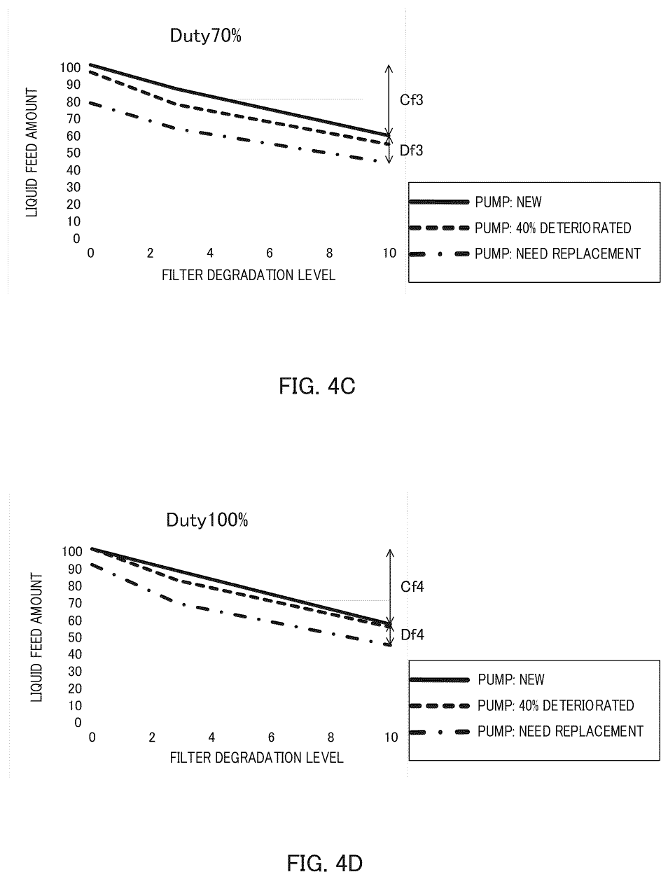

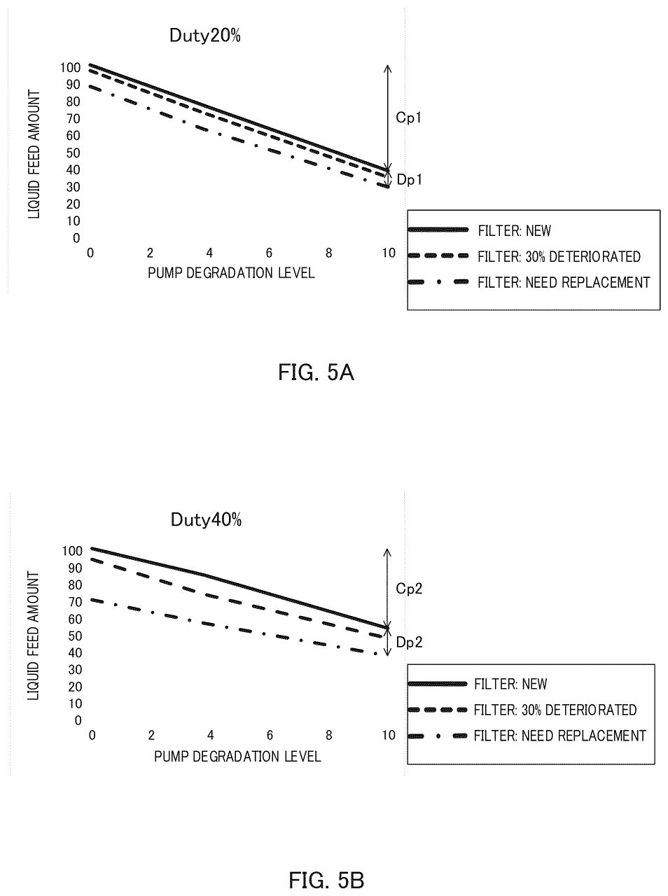

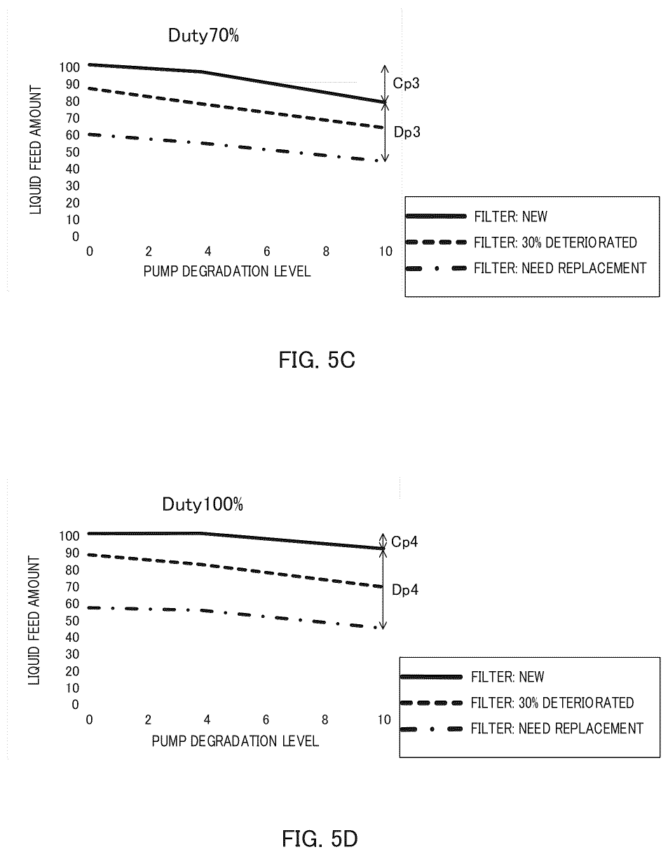

The setting of the pump duty will be described with reference to FIGS. 4A to 5D. First, with reference to FIGS. 4A to 4D, the reason why the pump duty at the time of filter diagnostics is made higher than the reference pump duty will be described.

FIGS. 4A to 4D are graphs illustrating a relationship between the filter degradation level and a liquid feed amount of the ink I. FIG. 4A is a graph of a case where the pump duty of the liquid feed pump 433 is 20%. FIG. 4B is a graph of a case where the pump duty of the liquid feed pump 433 is 40%. FIG. 4C is a graph of a case where the pump duty of the liquid feed pump 433 is 70%. FIG. 4D is a graph of a case where the pump duty of the liquid feed pump 433 is 100%.

In FIGS. 4A to 4D, the liquid feed amount of the ink I with respect to the filter degradation level is graphed with 100 set to the feed amount of the ink I when the filter 432 and the liquid feed pump 433 are new. Further, in FIGS. 4A to 4D, the filter degradation level of 0 (0%) indicates a state where the filter 432 is new, and the filter degradation level of 10 (100%) indicates a state where the filter 432 needs to be replaced (e.g., a state where a reference liquid feed amount cannot be obtained). Further, in FIGS. 4A to 4D, the cases where the liquid feed pump 433 is new, has deteriorated by 40%, and needs to be replaced are indicated by a solid line, a broken line, and a one dot chain line, respectively.

As illustrated in FIG. 4A, when the pump duty of the liquid feed pump 433 is 20%, the amount of change (slope) in the liquid feed amount of ink I with respect to the filter degradation level is smaller in any of the case where the liquid feed pump 433 is completely new, the case of 40% degradation, and the case where replacement is needed, in comparison with FIGS. 4B to 4D.

Referring also to FIGS. 4B to 4D, as the pump duty increases, the amount of change in the liquid feed amount of ink I with respect to the filter deterioration level increases in any of a case where the liquid feed pump 433 is completely new, a case where it is deteriorated by 40%, and a case where it needs to be replaced.

For example, in FIGS. 4A to 4D, regarding the change amount of the liquid feed amount of the ink I with respect to the filter degradation level when the liquid feed pump 433 is a new product, the change amounts from the filter degradation level 0 to the filter degradation level 10 are set to Cf1 to Cf4, respectively. In this case, Cf1<Cf2<Cf3<Cf4 holds, and when the pump duty of the liquid feed pump 433 is 100%, the amount of change in the liquid feed amount of ink I with respect to the filter degradation level is the largest.

In this manner, when diagnosing the filter degradation level, a relatively large pump duty at which the amount of change in the liquid feed amount of the ink I with respect to the filter degradation level becomes large is desirable, and 100%, which is the maximum value of the pump duty is most desirable.

Further, in a case where the pump duty of the liquid feed pump 433 is 20% as illustrated in FIG. 4A, the graph of the liquid feed amount of the ink I when the liquid feed pump 433 is new and the graph of the liquid feed amount of the ink I when the liquid feed pump 102 is 40% degraded and needs to be replaced are separated from each other as compared with FIGS. 4B to 4D. This means that the state of the deterioration level of the liquid feed pump 433 greatly affects the liquid feed amount of the ink I.

Referring also to FIGS. 4B to 4D, the graphs become closer to each other as the pump duty increases. This means a decrease in the influence of the state of the deterioration level of the liquid feed pump 433 on the liquid feed amount of the ink I.

For example, in FIGS. 4A to 4D, let Df1 to Df4 be differences between the liquid feed amount of the ink I at the filter degradation level 10 when the liquid feed pump 433 is new and the liquid feed amount of the ink I at the filter degradation level 10 when replacement is required. In this case, when Df1>Df2>Df3>Df4 holds and the pump duty of the liquid feed pump 433 is 100%, the influence of the state of the deterioration level of the liquid feed pump 433 is smallest.

As described above, when diagnosing the filter degradation level, a relatively large pump duty at which the influence of the state of the deterioration level of the liquid feed pump 433 is small is desirable, and the maximum value 100% of the pump duty is most desirable.

The pressure loss when the ink I passes through the filter 432 increases as the flow velocity of the ink I increases. That is, as the pump duty is increased, the influence of the deterioration of the filter 432 on the measurement of the liquid feed amount increases. Therefore, when the pump duty is increased, the influence of the deterioration of the filter 432 on the measurement of the liquid feed amount is increased, and thus the deterioration of the filter 432 can be diagnosed more accurately.

From the above, when diagnosing the filter degradation level, in the embodiment, the pump duty of 100% at which the change amount of the liquid feed amount of the ink I with respect to the filter degradation level is large and the influence of the state of the deterioration level of the liquid feed pump 433 is small is used.

Next, with reference to FIGS. 5A to 5D, the reason why the pump duty at the time of pump diagnostics is made lower than the reference pump duty will be described.

FIGS. 5A to 5D is a graph illustrating a relationship between the pump degradation level and a liquid feed amount of the ink I. FIG. 5A is a graph of a case where the pump duty of the liquid feed pump 433 is 20%. FIG. 5B is a graph of a case where the pump duty of the liquid feed pump 433 is 40%. FIG. 5C is a graph of a case where the pump duty of the liquid feed pump 433 is 70%. FIG. 5D is a graph of a case where the pump duty of the liquid feed pump 433 is 100%.

In FIGS. 5A to 5D, the feed amount of the ink I with respect to the pump degradation level is graphed with 100 set to the feed amount of the ink I when the filter 432 and the liquid feed pump 433 are new. In addition, in FIGS. 5A to 5D, the pump degradation level 0 (0%) indicates that the liquid feed pump 433 is completely new, and the pump degradation level 10 (100%) indicates a state where the liquid feed pump 433 needs to be replaced (e.g., a state where a reference liquid feed amount cannot be obtained). Further, in FIGS. 5A to 5D, the cases where the filter 432 is new, has deteriorated by 30%, and needs to be replaced are indicated by a solid line, a broken line, and a one dot chain line, respectively.

In a case where the pump duty of the liquid feed pump 433 is 20% as illustrated in FIG. 5A, the amount of change (inclination) in the liquid feed amount of the ink I with respect to the pump degradation level is large in any of the case where the filter 432 is new, the case where the filter 230 is deteriorated by 30%, and the case where the filter 230 needs to be replaced, as compared with 5B to 5D of FIG. 5A.

Referring also to 5B FIG. 5D, as the pump duty increases, the amount of change in the liquid feed amount of ink I with respect to the pump degradation level decreases in any of a case where the liquid feed pump 433 is completely new, a case where it is degraded by 30%, and a case where it is needs to be replaced.

For example, in FIGS. 5A to 5D, regarding the amount of change in the liquid feed amount of the ink I with respect to the pump degradation level when the liquid feed pump 433 is new, the amounts of change from the filter degradation level 0 to the filter degradation level 10 are denoted by Cp1 to Cp4, respectively. In this case, Cp1>Cp2>Cp3>Cp4 holds, and the amount of change in the liquid feed amount of ink I with respect to the pump degradation level is largest in a case where the pump duty of the liquid feed pump 433 is 20%.

As described above, when diagnosing the pump degradation level, a relatively small pump duty at which a change amount of the liquid feed amount of the ink I with respect to the pump degradation level becomes large is desirable, and the pump duty of 20% is most desirable.

Further, in a case where the pump duty of the liquid feed pump 433 is 20% as illustrated in FIG. 5A, the graph of the liquid feed amount of the ink I when the filter 432 is degraded by 30% and needs to be replaced is closer to the graph of the liquid feed amount of the ink I when the filter 230 is new compared with FIGS. 5B to 5D. This means that the influence of the state of the degradation level of the filter 432 on the liquid feed amount of the ink I is small.

Referring also to FIGS. 5B to 5D, the graphs are separated from each other as the pump duty increases. This means that the influence of the state of the degradation level of the filter 432 on the liquid feed amount of the ink I is increasing.

For example, in FIGS. 5A to 5D, the difference between the liquid feed amount of the ink I at the pump degradation level 10 when the filter 432 is new and the liquid feed amount of the ink I at the pump degradation level when replacement is necessary is Dp1 to Dp4, respectively. In this case, Dp1<Dp2<Dp3<Dp4 is satisfied, and 10 when the pump duty of the liquid feed pump 433 is 20%, the influence of the state of the degradation level of the filter 432 is smallest.

As described above, when diagnosing the pump degradation level, a relatively small pump duty at which the influence of the state of the degradation level of the filter 432 becomes small is desirable. Here, as an example, since the liquid feed pump 433 in which the settable minimum value of the pump duty is 20% is used, 20% is most desirable as the pump duty for diagnosing the pump degradation level. As long as the liquid feeding operation of the ink I can be guaranteed, liquid feed pumps having different minimum values may be used, and in this case, the minimum value of the pump duty of the liquid feed pump is most desirable as the pump duty for diagnosing the pump degradation level.

The pressure loss when the ink I passes through the filter 432 decreases as the flow rate of the ink I decreases. That is, when the pump duty is decreased, the influence of the deterioration of the filter 432 on the measurement of the liquid feed amount is reduced. Therefore, when the pump duty is reduced, the influence of the deterioration of the filter 432 on the measurement of the liquid feed amount is reduced, and the influence of the deterioration of the liquid feed pump 433 is increased, so that the deterioration of the liquid feed pump 433 can be more accurately diagnosed.

From the above, when diagnosing the pump degradation level, this embodiment uses the pump duty of 20% at which the change amount of the liquid feeding amount of the ink I with respect to the pump degradation level is large and the influence of the state of the degradation level of the filter 432 is small.

Based on the above findings, the deterioration level of at least one of the filter 432 and the liquid feed pump 433 can be accurately diagnosed by using the pump duty suitable for diagnosing the filter degradation level or the pump duty suitable for diagnosing the pump degradation level.

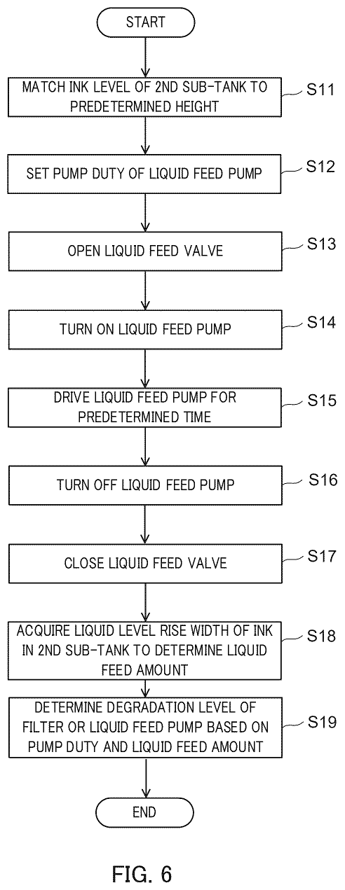

In the present embodiment, the feed amount of the ink I fed by the liquid feed pump 433 is measured using the liquid level sensor 445 of the second ink reservoir 440 as described below with reference to FIG. 6.

That is, in the present embodiment, it is possible to measure the liquid feed amount of the ink I fed by the liquid feed pump 433 without changing the configuration of the ink jet printer 100 or adding a new configuration. Therefore, in this embodiment, only by changing the pump duty of the liquid feed pump 433, it is possible to accurately diagnose the degradation level of the filter 432 or the liquid feed pump 433 without changing the configuration of the apparatus or adding a configuration.

### Diagnosis Method for Degradation Level

A diagnosis method for the degradation level of the filter 432 or the liquid feed pump 433 will be described with reference to FIG. 6 together with FIGS. 1 and 2. FIG. 6 is a flowchart illustrating a diagnosis method for the degradation level of the filter 432 or the liquid feed pump 433 in the ink supplier 40.

### Step S11

The diagnoser controls the ink supplier 40 to adjust the liquid level of the ink I in the second sub tank 441 to a predetermined height, for example, the lower limit of the second sub tank 441.

Specifically, when the liquid level of the ink I in the second sub tank 441 is higher than the lower limit, the diagnoser causes the ink I to be ejected from the nozzles of the inkjet head until the liquid level sensor 445 detects that the liquid level of the ink I reaches the lower limit. At this time, the same control as the operation of eliminating nozzle clogging described above is performed to eject the ink I from the nozzles of the inkjet head.

On the other hand, when the liquid level of the ink I in the second sub tank 441 is lower than the lower limit,

the diagnoser causes the sub-liquid feeder 430 to send the ink I from the first sub tank 421 to the second sub tank 441 until the liquid level sensor 445 detects that the liquid level of the ink I reaches the lower limit. At this time, since the liquid level can be accurately adjusted to the lower limit by slowly feeding the liquid, it is desirable that the pump duty of the liquid feed pump 433 is 20%, which is a settable minimum value.

### Step S12

The diagnoser sets a pump duty of the liquid feed pump 433. In the present embodiment, as described above, the diagnoser sets the pump duty to 100% when diagnosing the filter degradation level and sets the pump duty to 20% when diagnosing the pump degradation level.

### Steps S13 to S17

The diagnoser opens the liquid feed valve 434, turns on the liquid feed pump 433, drives the liquid feed pump 433 at the set pump duty for a predetermined time (e.g., 5 seconds), and then turns off the liquid feed pump 433 and closes the liquid feed valve 434.

As the predetermined time, in a case where the filter 432 and the liquid feed pump 433 are new, the number of seconds for which the liquid level rises to the target height is set in advance. As the predetermined height is higher, the accuracy of the deterioration level diagnosis is more improved, but in order to avoid an error of the upper limit, the predetermined height is set with a margin up to the upper limit. For example, if the detection of the upper limit is 30 mm, 20 mm is set as the target height. In a case where the filter 432 and the liquid feed pump 433 are new products, when the liquid feeding speed is 4 mm/s, the predetermined time is set to 5 seconds.

In addition, since the pump duty is set to 100% for diagnosing the filter degradation level and the pump duty is set to 20% for diagnosing the pump degradation level, the time for which the liquid level rises to the target height is set as the predetermined time according to the pump duty.

### Step S18

The diagnoser measures the liquid level height of the ink I in the second sub tank 441 by the liquid level sensor 445 and acquires a liquid level rise width from a predetermined height (the lower limit of the second sub tank 441). When the filter 432 or the liquid feed pump 433 is deteriorated by use, the liquid feeding speed decreases. For example, in a case where the liquid feed speed decreases to 3 mm/s, when the liquid feed pump 433 is driven for 5 seconds, the liquid level rise width becomes 15 mm. The diagnoser can obtain the amount of the ink I fed by the liquid feed pump 433 from the liquid level rise width.

### Step S19

The diagnoser obtains the degradation level of the filter 432 and the liquid feed pump 433 based on the set pump duty and the obtained liquid feed amount. For example, the diagnoser can accurately diagnose the degradation level of the filter 432 or the liquid feed pump 433 with reference to the graphs illustrated in FIGS. 4A to 5D based on the set pump duty and the obtained liquid feed amount.

As described above, in the present embodiment, the ink supplier 40 includes the diagnoser. The diagnoser drives the liquid feed pump 433 at a second set value (pump duty 20%, 100%) different from the first set value (pump duty 40%) related to the normally used driving force, and acquires a numerical value related to the liquid feed amount fed to the second ink reservoir 440. Then, the diagnoser diagnoses the deterioration level of at least one of the liquid feed pump 433 and the filter 432 based on the acquired numerical value.

According to the present embodiment configured as described above, since the pump duty suitable for diagnosing the filter degradation level and the pump degradation level is used, it is possible to accurately diagnose the deterioration level of at least one of the filter 432 and the liquid feed pump 433.

Further, in the present embodiment, since it is not necessary to change the apparatus configuration or add a new configuration to the apparatus, it is possible to accurately diagnose the deterioration level of at least one of the filter 432 and the liquid feed pump 433 with a simple configuration.

Note that the liquid feed amount is obtained based on the liquid level height of the ink I in the second sub tank 441 in the present embodiment, but for example, a flowmeter may be provided in the sub-liquid feeder 430, and the liquid feed amount may be obtained based on a measurement result (flow velocity or flow rate) of the flowmeter. In this case, it is desirable to set the predetermined time for driving the liquid feed pump 433 to a time at which the measurement accuracy of the flowmeter can be sufficiently obtained.

### Modification 1

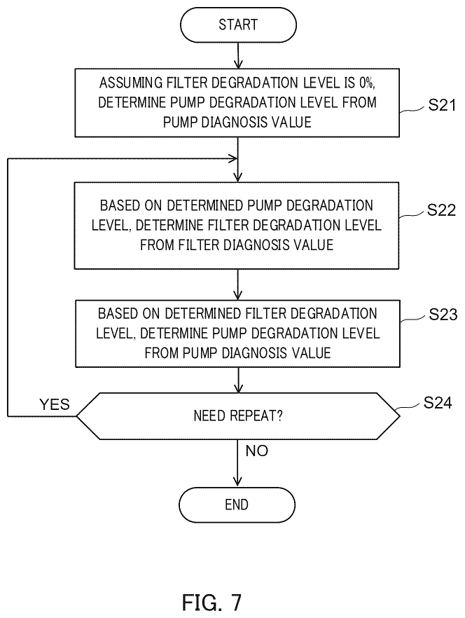

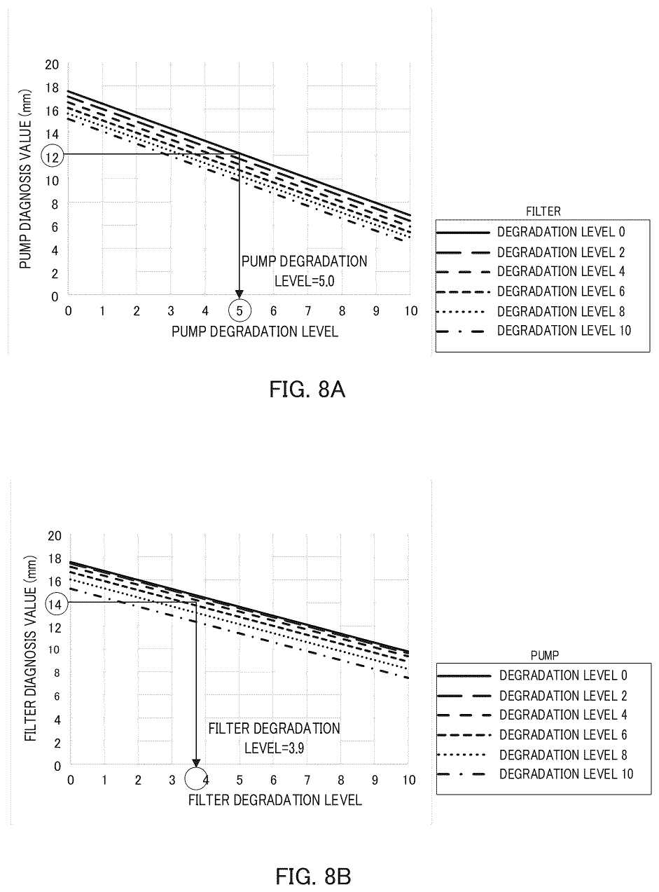

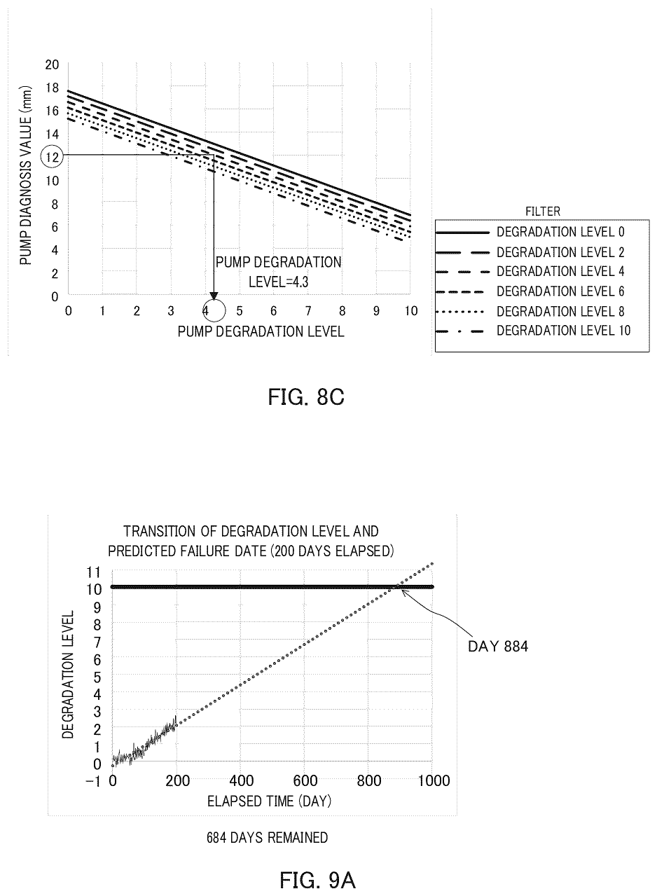

FIG. 7 is a flowchart illustrating a method of more accurately diagnosing the degradation level of the filter 432 and the liquid feed pump 433 by combining the filter diagnosis and the pump diagnosis in the ink supplier 40. FIGS. 8A to 8C are diagrams illustrating a method of calculating the filter degradation level and the pump degradation level by combining the filter diagnosis and the pump diagnosis. FIG. 8A is a diagram illustrating a method of calculating the pump degradation level from the pump diagnosis value. FIG. 8B is a diagram illustrating a method of calculating the filter degradation level from the filter diagnosis value on the basis of the pump degradation level calculated in FIG. 8A. FIG. 8C is a diagram illustrating a method of calculating the pump degradation level from the pump diagnosis value on the basis of the filter degradation level calculated in FIG. 8B.

In the above-described embodiment, the degradation level of the filter 432 and the liquid feed pump 433 are diagnosed using the pump duty suitable for diagnosing the filter degradation level and the pump degradation level. Based on the diagnosis of the filter degradation level and the pump degradation level described in the above embodiment, the deterioration levels of the filter 432 and the liquid feed pump 433 can be more accurately diagnosed by the method described below.

### Step S21

The diagnoser assumes that the filter degradation level is 0%, and obtains the pump degradation level from the pump diagnosis value. Here, the pump diagnosis value is a liquid level rise width at the time of pump diagnosis in the flowchart illustrated in FIG. 6. The pump diagnosis value is acquired by the method described in FIG. 6. The diagnoser acquires and holds in advance data indicating the relationship between the pump diagnosis value and the pump degradation level for each of the filter degradation level, which is illustrated in the graph of FIG. 8A. The pump degradation level is expressed as 0 (0%) when the pump is new and as 10 (100%) when the pump needs to be replaced.

Here, it is assumed that the filter degradation level is 0%, and as an example, since the pump diagnosis value is 12 mm, the pump degradation level can be obtained as 50% from the graph of the filter degradation level of 0% shown in 8A of the drawing.

### Step S22

The diagnoser obtains the filter degradation level from the filter diagnosis value based on the obtained pump deterioration level. Here, the filter diagnosis value is a liquid level rise width at the time of filter diagnosis in the flowchart illustrated in FIG. 6. The filter diagnosis value is acquired by the method described in FIG. 6. Note that the diagnoser acquires and holds, in advance, data indicating a relation between the filter diagnosis value and the filter degradation level for each pump deterioration level, illustrated in the graph of FIG. 8B. The filter degradation level is expressed as 0 (0%) when the filter is new and as 10 (100%) when the filter needs to be replaced.

Here, since the pump degradation level is 50% and, as an example, the filter diagnosis value is 14 mm, it is possible to diagnose that the filter degradation level is 3.9% from the graph of the pump degradation level of 50% in 8B of the drawing. Although the graph of the pump degradation level of 50% is not illustrated in FIG. 8B, for example, the graph of the pump degradation level of 50% can be created from the data of the graph illustrated in FIG. 8B. Further, even if the graph of the pump degradation level of 50% is not prepared, the filter degradation level corresponding to the filter diagnosis value at the time of the pump degradation level of 50% can be obtained from the data.

### Step S23

The diagnoser obtains the pump degradation level from the pump diagnosis value based on the obtained filter degradation level.

Here, since the filter degradation level is 3.9% and the pump diagnosis value is the above-described 12 mm, the pump degradation level can be diagnosed as 4.3% from the graph of the filter degradation level of 3.9% in FIG. 8C. Although the graph of the filter degradation level of 3.9% is not illustrated in FIG. 8C, for example, the graph of the filter degradation level of 3.9% can be created from the data of the graph illustrated in FIG. 8C. Further, the pump degradation level corresponding to the pump diagnosis value at the filter degradation level of 3.9% can be obtained from the data without preparing the graph of the filter degradation level of 3.9%. Note that the graph itself illustrated in FIG. 8C is the same as the graph illustrated in FIG. 8A.

### Step S24

The diagnoser determines whether it is necessary to repeat the flow. For example, the user may set the number of repetitions in advance, or the diagnoser may determine whether or not to repeat by determining whether or not the filter degradation level and the pump degradation level have converged. In a case where the repetition is necessary (YES), the process returns to step S22, and in a case where the repetition is not necessary (NO), a series of flows is ended.

In the present modification, since the filter degradation level and the pump degradation level are diagnosed again based on the relationship between the filter degradation level and the pump degradation level, the deterioration levels of the filter 432 and the liquid feed pump 433 can be diagnosed more accurately. Further, by repeating the flow, the deterioration levels of the filter 432 and the liquid feed pump 433 can be diagnosed more accurately.

### Modification 2

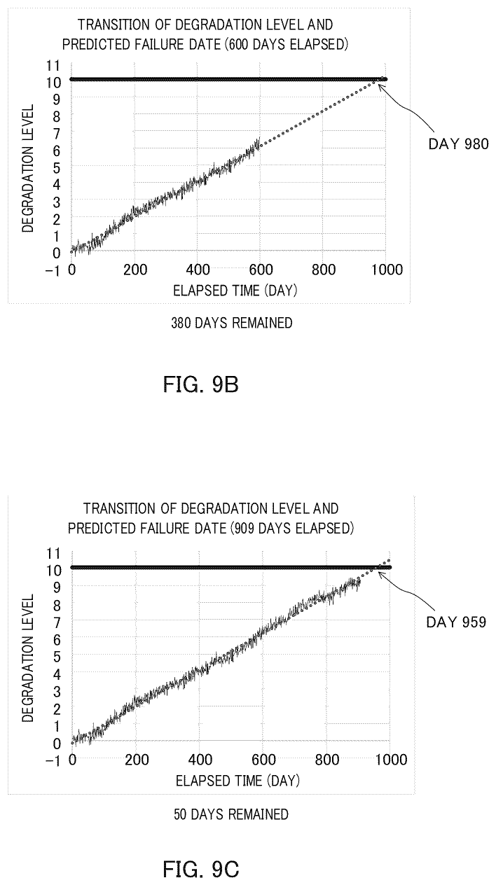

FIGS. 9A to 9C are diagrams illustrating an example of a method of recommending replacement of a filter 432 of an ink supplier 40. FIG. 9A is a graph illustrating transition of the filter degradation level and an approximate expression for predicting the failure time at a time point when 200 days have elapsed from the start of use. FIG. 9B is a graph illustrating transition of the filter degradation level at a time point after two days from the start of use, and an approximate expression for predicting a failure timing. FIG. 9C is a graph illustrating transition of the filter degradation level and an approximate expression for predicting the failure time at the time when two days have elapsed from the start of use.

In the above embodiment and the first modification, the diagnoser obtains the filter degradation level. However, it is possible to recommend the replacement of the filter 432 using the obtained filter degradation level. Note that here, as an example, the replacement of the filter 432 is recommended, but the replacement of the liquid feed pump 433 can also be recommended similarly, and here, the description of the liquid feed pump 433 will be omitted.

The diagnoser can predict the failure time of the filter 432 and recommend the replacement of the filter 432 to the user by, for example, measuring and recording the filter degradation level obtained in the above-described embodiment and modified example 1 every day and grasping the tendency thereof.

For example, the diagnoser executes the diagnostic mode or the like before shutdown or the like after a job end in the inkjet printer 100 to acquire the filter degradation level. The diagnosis mode may be performed for each operation day of the ink jet printer 100, or the frequency of performing the diagnosis mode may be lowered in a case where the ink I that is unlikely to deteriorate is used.

The sub-liquid feeder 430 having the filter 432 and the liquid feed pump 433 is provided for each color, and some apparatuses have a plurality of sub-liquid feeders 430 for the same color. If the diagnosis mode can be independently performed in all of the sub-liquid feeders 430 of the diagnoser performs the diagnosis of the diagnostic mode is performed on all the sub-liquid feeders 430 simultaneously in parallel. When there is a sub-liquid feeder 430 that cannot perform the diagnostic mode simultaneously in parallel, the diagnostic mode may be performed sequentially, or the diagnostic mode may be performed on a different day.

The filter degradation level obtained by the execution of the diagnostic mode is, for example, recorded in the memory 94 or recorded in a memory apparatus of the external apparatus 200 via the input/output interface 80. As will be described below, the diagnoser predicts a failure time of the filter 432 from the transition of the recorded the filter degradation level, and recommends replacement.

Specifically, the diagnoser obtains an approximate expression for predicting the failure time, for example, by the method of least squares, on the basis of transition of the filter degradation level with respect to the number of elapsed days after start of use of the completely new filter 432. The number of days until the filter degradation level reaches 100% is obtained by using the obtained approximate expression, and the remaining number of days for which the filter 432 can be used is obtained from the number of days.

For example, as illustrated in FIG. 9A, at the point in time when 200 days have elapsed from the start of use of the new filter 432, the diagnoser obtains an approximate expression (see the broken line in the drawing) for predicting the failure time by the least-squares method based on the transition of the filter degradation level with respect to the number of elapsed days. The number of days 884 when the filter degradation level reaches 100% is obtained by using the obtained approximate expression, and the remaining number of days 684 when the filter 432 can be used is obtained from the number of days. Note that in FIGS. 9A to 9C, the degradation level is expressed as 0 (0%) for a completely new product and as 10 (100%) for a state requiring replacement.

Similarly, as illustrated in FIG. 9B, at the point in time when 600 days have elapsed from the start of use of the new filter 432, the diagnoser obtains an approximate expression (see the broken line in the drawing) for predicting the failure time by the least-squares method based on the transition of the filter degradation level with respect to the number of elapsed days. The number of days 980 when the filter degradation level reaches 100% is obtained by using the obtained approximate expression, and the remaining number of days 380 when the filter 432 can be used is obtained from the number of days.

Similarly, as illustrated in FIG. 9C, at the point in time when 909 days have elapsed from the start of use of the new filter 432, the diagnoser obtains an approximate expression (see the broken line in the drawing) for predicting the failure time by the least-squares method based on the transition of the filter degradation level with respect to the number of elapsed days. The number of days 959 when the filter degradation level reaches 100% is obtained by using the obtained approximate expression, and the remaining number of days 50 when the filter 432 can be used is obtained from the number of days.

When the number of remaining days reaches a predetermined number of days, for example, one day, the diagnoser notifies the user of a message recommending replacement of the filter 432 using, for example, the operation display 70. The smaller the predetermined number of days, the longer the filter 432 can be used. However, it is necessary to set the predetermined number of days in consideration that the replacement time is secured with a margin and a certain degree of error is included in the predicted remaining number of days. Here, as an example, the predetermined number of days is set to one day.

As described above, the diagnoser can predict the failure time of the filter 432 based on the transition of the filter degradation level with respect to the number of elapsed days after the start of use of the new filter 432, predict the replacement timing, and notify the user of the replacement recommendation message of the filter 432.

The same applies to the liquid feed pump 433. That is, the diagnoser can predict the failure time of the liquid feed pump 433 based on the transition of the pump degradation level with respect to the number of elapsed days after the start of use of the new liquid feed pump 433, predict the replacement timing, and notify the user of the replacement recommendation message of the liquid feed pump 433.

### Modification 3

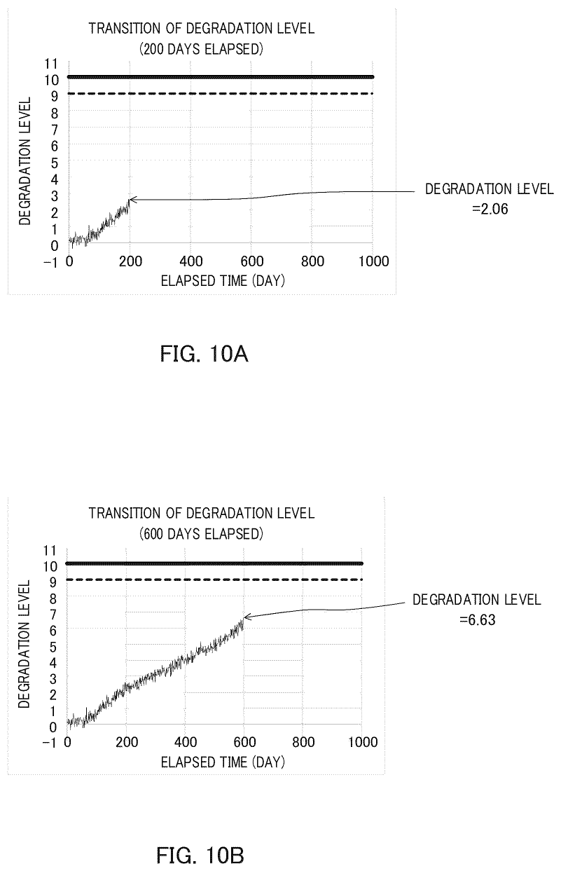

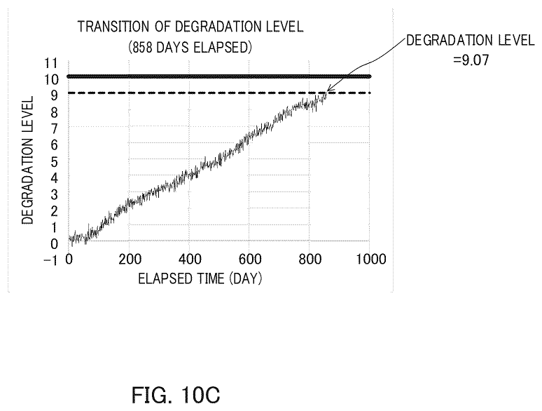

FIGS. 10A to 10C are diagrams illustrating another example of a method of recommending replacement of the filter 432 of the ink supplier 40. FIG. 10A is a graph illustrating transition of the filter degradation level and a determination value of the filter degradation level at which replacement is recommended at a time point when 200 days elapsed from the start of use. FIG. 10B is a graph illustrating transition of the filter degradation level and a determination value of the filter degradation level at which replacement is recommended at a time point when 600 days elapsed from the start of use. FIG. 10C is a graph illustrating transition of the filter degradation level and a determination value of the filter degradation level at which replacement is recommended at a time point when 858 days elapsed from the start of use.

The diagnoser may recommend the replacement of the filter 432 not only by the above modification 2 but also by a method described below. Note that here also, as an example, replacement of the filter 432 is recommended, but replacement of the liquid feed pump 433 can be recommended in a similar manner, and here, description of the liquid feed pump 433 is omitted.

The diagnoser can measure and record the filter degradation level obtained in the above-described embodiment and the first modification, for example, daily in the above-described diagnosis mode, and recommend the user to replace the filter 432 based on the measured filter degradation level and the determination value of the filter degradation level.

For example, as illustrated in FIG. 10A, the diagnoser determines whether or not replacement is recommended based on the measured filter degradation level and the determination value when 200 days have elapsed from the start of use of the new filter 432.

The larger the determination value is, the longer the filter 432 can be used. However, the measured filter deterioration level includes a certain degree of error, and if the determination value is too large, it is possible that the filter actually needs to be replaced although the measured filter deterioration level is lower than the determination value. Therefore, it is necessary to set the determination value in consideration of such a matter, and here, as an example, the determination value is set as 10%).

At the time point after 200 days from the start of use illustrated in FIG. 10A, the filter degradation level is 2.06

and does not reach the determination value 9, and therefore, the diagnoser does not recommend replacement of the filter 432. Note that in FIGS. 10A to 10C, the degradation level is expressed as 0 (0%) for a completely new product and as 10 (100%) for a state requiring replacement.

Similarly, as illustrated in FIG. 10B, the diagnoser determines whether or not replacement is recommended based on the measured filter degradation level and the determination value at the time when 600 days have elapsed from the start of use of the new filter 432. At the point in time when 600 days have elapsed since the start of use, the filter degradation level is 6.63 and has not reached the determination value of 9, and therefore, the diagnoser does not recommend replacement of the filter 432.

Similarly, as illustrated in FIG. 10C, the diagnoser determines whether or not replacement is recommended based on the measured filter degradation level and the determination value at the time when 858 days have elapsed from the start of use of the new filter 432. At the time when 858 days have elapsed from the start of use, the filter degradation level is 9.07, which exceeds the determination value of 9. Therefore, the diagnoser notifies the user that replacement of the filter 432 is recommended, for example, by using the operation display 70.

As described above, the diagnoser can notify the user of the replacement recommendation message of the filter 432 based on the measured filter degradation level and the determination value thereof.

The same applies to the liquid feed pump 433. That is, the diagnoser can notify the user of a replacement recommendation message of the liquid feed pump 433 based on the measured pump deterioration level and the determination value thereof.

### Modification 4

In the second and third modifications, the diagnoser predicts the failure timing of the filter 432 or the liquid feed pump 433 by using the obtained filter degradation level or pump degradation level. However, the pump duty of the liquid feed pump 433 may be calibrated by using these.

In a normal liquid feeding operation of sending the ink I from the first ink reservoir 420 to the second ink reservoir 440, a predetermined pump duty (for example, a pump duty of 40%) is set so as to obtain a sufficient liquid feeding amount. In addition, a predetermined pump duty (for example, a pump duty of 40%) is set such that a sufficient pressure is obtained in the second sub tank 441 at the time of the ink circulation operation performed in a case where air bubbles enter the ink jet head of the head module 50.

However, when the filter 432 and the liquid feed pump 433 deteriorate due to use and the deterioration progresses to a certain extent, the liquid feeding operation of the ink I cannot be appropriately performed, a sufficient pressure cannot be obtained in the second sub tank 441, and the ink circulation operation cannot be appropriately performed. For this reason, the liquid feeding operation and the ink circulation operation take more time than usual, and in some cases, an error occurs and the ink jet printer 100 is stopped.

Therefore, in the present modification, in order to prevent the occurrence of the above-described problem, the diagnoser determines, based on the obtained filter degradation level and pump degradation level, whether or not the ink feeding force during the liquid feeding operation and the ink circulation operation is reduced. Then, in a case where the ink liquid feed force during the liquid feed operation or the ink circulation operation is reduced, the diagnoser calibrates the pump duty during the liquid feed operation or the ink circulation operation to an appropriate value based on the obtained filter degradation level or pump deterioration level.

The determination of whether or not the ink feeding force is reduced and the calibration of the pump duty to an appropriate value are performed, for example, by the following method.

### Calibration Method 1

(1-1) A determination table for determining whether or not ink feedability has decreased is created in advance based on experimental values, and the determination table is stored in, for example, the memory 94 so that the diagnoser can refer to it. Next, the diagnoser refers to the determination table, determines, based on the obtained filter degradation level and pump deterioration level, whether or not the ink feeding force is reduced, and determines whether or not it is necessary to change the pump duty. For example, with reference to the determination table, the diagnoser determines that the pump duty needs to be changed when the ink feeding force decreases by 10%.
(1-2) The diagnoser increases the pump duty by a predetermined % (e.g., 10%) at a time from the currently set pump duty and acquires the liquid level rise width using the flow described in FIG. 6. When it is determined that a sufficient liquid feeding amount can be obtained from the obtained liquid level rise width, the diagnoser sets the pump duty at that time as an appropriate pump duty during the liquid feeding operation or the ink circulation operation.

### Calibration Method 2

(2-1) The diagnoser holds in advance a calculation formula for calculating an appropriate pump duty at the time of the liquid feeding operation or the ink circulation operation from the filter degradation level or the pump degradation level. When the coefficient of the calculation formula is obtained, for example, the coefficient may be obtained by machine learning of the relationship between the experimental result and the deterioration level, or may be obtained by using an approximation formula based on the experimental result.
(2-2) The diagnoser calculates the pump duty from the calculation formula on the basis of the obtained filter degradation level and pump degradation level, and sets the calculated pump duty as an appropriate pump duty for the liquid feed operation and the ink circulation operation.

By calibrating the pump duty at the time of the liquid feeding operation or the ink circulation operation to an appropriate pump duty by the above-described method, the liquid feeding operation or the ink circulation operation can be appropriately performed even when the filter 432 or the liquid feed pump 433 is deteriorated.

The above-described embodiment and modifications are merely examples of embodiments for carrying out the present invention, and the technical scope of the present invention should not be interpreted in a limited manner by these. That is, the present invention can be implemented in various forms without departing from the spirit or main features thereof.

For example, the ink supplier 40 that is the liquid feeding apparatus according to the present invention feeds ink, but the liquid feeding apparatus according to the present invention is applicable to a case of feeding liquid other than ink.

Although embodiments of the present invention have been described and illustrated in detail, the disclosed embodiments are made for purpose of illustration and example only and not limitation. The scope of the present invention should be interpreted by terms of the appended claims.

What is claimed is:

1. A liquid feeding apparatus comprising:
a flow path including a pump that feeds liquid from a first reservoir to a second reservoir, and a filter that collects foreign matters from the liquid fed; and
a hardware processor,
wherein the hardware processor acquires a numerical value related to a liquid feed amount of the liquid fed to the second reservoir by driving the pump with at least one second set value different from a first set value related to a normally used driving force, and diagnoses a deterioration level of at least one of the pump and the filter based on the numerical value.

2. The liquid feeding apparatus according to claim 1, wherein when the hardware processor diagnoses the degradation level of the filter, the second set value is larger than the first set value.

3. The liquid feeding apparatus according to claim 1, wherein when the hardware processor diagnoses the degradation level of the pump, the second set value is smaller than the first set value.

4. The liquid feeding apparatus according to claim 1, wherein the hardware processor diagnoses the degradation level of the filter and the pump again based on a relationship between the degradation level of the filter and the degradation level of the pump.

5. The liquid feeding apparatus according to claim 1, wherein the hardware processor predicts a replacement timing of the filter based on transition of the degradation level of the filter, and provides a notification of a replacement recommendation message to a user.

6. The liquid feeding apparatus according to claim 1, wherein the hardware processor predicts a replacement timing of the pump based on transition of the degradation level of the pump, and provides a notification of a replacement recommendation message to a user.

7. The liquid feeding apparatus according to claim 1, wherein the hardware processor calibrates the first set value such that a liquid feeding amount of the liquid to be fed to the second reservoir becomes a predetermined liquid feeding amount based on the degradation level of the filter and the degradation level of the pump.

8. The liquid feeding apparatus according to claim 1, wherein the numerical value related to the liquid feed amount is a liquid level height in the second reservoir.

9. An image forming apparatus comprising:
a first reservoir and a second reservoir that store ink;
the liquid feeding apparatus according to claim 1 that feeds the ink; and
an image former that forms an image using the ink supplied from the second reservoir.

10. A diagnosis method for a liquid feeding apparatus, the liquid feeding apparatus including a flow path including a pump that feeds liquid from a first reservoir to a second reservoir, and a filter that collects foreign matters from the liquid fed, the method comprising:
acquiring a numerical value related to a liquid feed amount of the liquid fed to the second reservoir by driving the pump with at least one set value different from a set value related to a normally used driving force, and diagnosing a deterioration level of at least one of the pump and the filter based on the numerical value.
